(19) United States
(12) Patent Application Publication
(10) Pub. No.: US 2021/0238480 A1
(43) Pub. Date: Aug. 5, 2021

(54) COMPOUND FOR CAPTURING CARBON DIOXIDE AND IMPROVING SOIL ARABILITY

(71) Applicant: Kalib Riddle, Baltimore, OH (US)

(72) Inventor: Kalib Riddle, Baltimore, OH (US)

(21) Appl. No.: 17/163,686

(22) Filed: Feb. 1, 2021

Related U.S. Application Data
(60) Provisional application No. 62/968,655, filed on Jan. 31, 2020.

(51) Int. Cl. C09K 17/06; C01F 11/02; C01B 33/12; C01F 5/02

(52) U.S. Cl. CPC C09K 17/06; C01F 11/02; C09K 2101/00; C01F 5/02; C01P 2004/61; C01B 33/12

(57) ABSTRACT

Disclosed is a compound for capturing carbon dioxide and improving the arability of soil. The compound includes a quantity of calcium hydroxide and a quantity of basalt. The calcium hydroxide improves the arability of soil by raising soil alkalinity and acting as a pH buffer to prevent it from becoming too acidic. The quantity of basalt sequesters carbon dioxide by providing reactive minerals capable of facilitating carbon mineralization. Also disclosed are methods of making and experimental results demonstrating the compound's efficacy.

### CROSS-REFERENCE TO RELATED APPLICATION

This application is a non-provisional patent application that makes a priority claim to U.S. Provisional Application No. 62/968,655.

### TECHNICAL FIELD

Exemplary embodiments of the present invention relate generally to a compound for capturing carbon dioxide and improving soil arability.

### BACKGROUND

It has long been known that the build-up of atmospheric carbon dioxide is a leading cause of global climate change. Like other greenhouse gasses, atmospheric carbon dioxide traps heat absorbed by the sun, thereby contributing to an increase in global surface temperatures (e.g., global warming). In effect, this can lead to the destabilization of ostensibly most ecosystems and natural processes, many of which life on Earth depends on (including humans).

For example, carbon dioxide can react with water to yield carbonic acid. Thus, when the concentration of atmospheric carbon dioxide increases, so too does the concentration of carbonic acid in places where there is water, such as our oceans, lakes, and on the land (especially farmland). The increased concentration of carbonic acid can lead to the acidification of those places, thereby disrupting the delicate pH balance of those places.

Further, the increase in global surface temperatures has been shown to increase the concentration of atmospheric water vapor, which itself is a greenhouse gas. In many places, more atmospheric water vapor can lead to increased rainfall, which is known to wash away soil alkalinity and further contribute to soil acidification.

Accordingly, those skilled in the art continue with research and development efforts in the field of preventing the compounding effects of atmospheric carbon dioxide build-up.

### SUMMARY OF THE INVENTION

Disclosed are compounds for capturing carbon dioxide and improving soil arability.

In one embodiment, the compound includes a quantity of calcium hydroxide and a quantity of basalt. The quantity of basalt includes a combined magnesium oxide and silicon oxide content of at least 20% by weight. Further, quantity of calcium hydroxide is relative to the quantity of basalt at a ratio ranging from about 1:6 to about 6:1 by weight.

In another embodiment, the compound includes a quantity of calcium hydroxide and a quantity of basalt. At least one of the quantities of basalt and the quantity of calcium hydroxide is in a dry particulate form, and the quantity of calcium hydroxide is relative to the quantity of basalt at a ratio ranging from about 3:2 to about 7:13 by weight.

In yet another embodiment, the compound include a quantity of calcium hydroxide and a quantity of basalt. The quantity of basalt includes the minerals forsterite and anorthite, as well as a quantity of at least one of iron, potassium, potassium oxide, phosphate, aluminum oxide, and sodium oxide.

Further features and advantages of the compound disclosed herein are described in detail below with reference to the accompanying figures.

### BRIEF DESCRIPTION OF THE DRAWINGS

In addition to the features mentioned above, other aspects of the present invention will be readily apparent from the following descriptions of the drawings and exemplary embodiments, wherein the reference numerals across the several views refer to identical or equivalent features, and wherein:

FIG. 1 graph diagram showing the average weight increase of the basalt of Experiment 1 for each group of vessels;

FIG. 2 is a table diagram showing the growth of sweet corn over an eight-week period;

FIG. 3 is a graph diagram showing the growth of sweet corn tabulated in FIG. 2; and

FIG. 4 is a graph diagram showing the average growth of sweet corn per week as tabulated in FIG. 2.

### DETAILED DESCRIPTION

Various embodiments of the present invention will now be described in detail with reference to the accompanying drawings. In the following description, specific details such as detailed configuration and components are merely provided to assist the overall understanding of these embodiments of the present invention. Therefore, it should be apparent to those skilled in the art that various changes and modifications of the embodiments described herein can be made without departing from the scope and spirit of the present invention. In addition, descriptions of well-known functions and constructions are omitted for clarity and conciseness.

Embodiments of the invention are described herein with reference to illustrations of idealized embodiments (and intermediate structures) of the invention. As such, variations from the shapes of the illustrations as a result, for example, of manufacturing techniques and/or tolerances, are to be expected. Thus, embodiments of the invention should not be construed as limited to the particular shapes of regions illustrated herein but are to include deviations in shapes that result, for example, from manufacturing.

Disclosed herein is a compound for capturing carbon and improving soil arability. The compound may be applied to any type of soil but may be most suitable for soil in crop-growing environments such as farmland and gardens. The compound improves the arability of this soil by raising the soil alkalinity and acting as a pH buffer to prevent it from becoming too acidic. Further, the compound also sequesters carbon dioxide by providing reactive minerals capable of facilitating carbon mineralization. Compositions and methods for making are described in detail below.

The compound includes, among other things, a quantity of calcium hydroxide. When applied to soil, or otherwise exposed to the environment, the calcium hydroxide undergoes carbonatation to react with carbon dioxide (e.g., atmospheric or in solution) and form calcium carbonate:

Ca(OH)₂+CO₂→CaCO₃+H₂O Reaction 1

Calcium carbonate (also known as calcite) is generally insoluble and thus achieves short-term capture of carbon dioxide. However, when present in soil, calcium carbonate can also react with carbonic acid (an acidic component of soil) to form calcium bicarbonate:

CaCO₃+H₂CO₃→Ca(HCO₃)₂ Reaction 2

By this reaction, application of the compound can effectively serve as a soil pH buffer and raise the alkalinity of soil, resulting in a better growing environment for many types of crops and plants. Further, by converting carbon dioxide to anionic carbonate, the compound enables the subsequent formation of carbonate minerals when cationic elements are added.

It is one aspect of the present invention to improve the process described above by supplementing calcium hydroxide with a quantity of basalt. Basalt is an abundant type of igneous rock typically consisting of amphibole, mica, olivine, plagioclase, and pyroxene minerals. These silicate minerals can be a source of cationic metals (e.g., magnesium, calcium, aluminum and iron) and nonmetals (e.g., sodium, phosphorous, and potassium) that will react with carbon dioxide and/or carbonate to form carbonate minerals. For example, reaction 3 shows the reaction of the olivine mineral forsterite (which is an endmember of the olivine solid solution series) with carbon dioxide, and reaction 4 shows the reaction of anorthite (which is the calcium endmember of the plagioclase feldspar mineral series) with carbon dioxide and water:

Mg₂SiO₄+2CO₂→2MgCO₃+SiO₂ Reaction 3

CaAl₂Si₂O₅+CO₂+2H₂O→Al₂Si₂O₅(OH)₄+CaCO₃ Reaction 4

Referring to reaction 3, the orthosilicate is replaced by carbonate to form magnesium carbonate, which is geologically stable and thus achieves long-term capture of carbon dioxide. Referring to reaction 4, the anorthite is converted to kaolinite and, in the process of doing so, sequesters carbon dioxide by converting it to calcium carbonate and thereby furthering carbon mineralization later down the line.

Further, basalt can be a source of metal oxides that also form carbonate minerals. In particular, basalt contains a relatively high concentration of magnesium oxide and calcium oxide when compared to other types of igneous rock. The presence of magnesium oxide in basalt enables the formation of dolomite when it is reacted with calcium hydroxide, carbonic acid, and carbon dioxide:

Ca(OH)₂+MgO+H₂CO₃+CO₂→CaMg(CO₃)₂+2H₂O Reaction 5

The above equation, in and of itself, shows how calcium hydroxide and basalt can be complementary. When present in the same compound, they enable both the long-term storage of carbon dioxide as well as a reduction in the environmental concentration of carbonic acid, thereby improving soil arability.

Carbon sequestration aside, it is also noted that the addition of basalt to soil may provide many trace elements that can facilitate plant growth by increasing root vitality and healthy development. In particular, it is contemplated that the silica content of basalt may be beneficial due its ability to strengthen plant cell walls and ward off fungal diseases such as powdery mildew.

The relative quantities of calcium hydroxide and basalt in the compound may be varied as needed without departing from the scope of the present disclosure. In many cases, the compound may even be tailored to the soil to which it will be added. For example, if the soil is particularly acidic then it may be appropriate to apply an embodiment of the compound with a relatively high calcium hydroxide content. Alternatively, if soil pH is less of a concern then embodiments containing a higher basalt content may be appropriate so as to capture more carbon dioxide. In any case, it is generally contemplated that an ideal ratio of calcium hydroxide to basalt (by weight) may range from about 1:6 to about 6:1, and preferably from about 1:4 to about 4:1, and even more preferably about 3:2 to about 7:13.

Additionally, the specific material composition of the basalt may also be subject to variation. In one embodiment, the compound may include a quantity of basalt having a magnesium content (by weight) of about 20% to about 50%, but preferably from about 30% to about 40%. In another embodiment, the compound may include a quantity of basalt having a combined magnesium oxide and silicon oxide content (by weight) of at least 20%, but preferably of at least 40%. In yet another embodiment, the compound may include a quantity of basalt comprising at least trace quantities of at least one of iron, potassium, potassium oxide, phosphate, aluminum oxide, and sodium oxide. Variations in the material composition of basalt like the ones described above will not result in a departure from the scope of the present disclosure.

Preparing the compound is a simple procedure that generally entails portioning out the desired quantities of calcium hydroxide and basalt, and then mixing these components until a substantially homogenous compound is achieved. The basalt may be sourced in any available form but will likely be a crushed rock, pellet, or powder. Similarly, calcium hydroxide is readily available in pellet or powder form, however it is also contemplated that aqueous calcium hydroxide may also be used. In a preferred embodiment, the basalt and calcium hydroxide may each be sourced in a dry particulate form with the basalt having an average particle size of about 6 μm to about 300 μm, but preferably about 12 μm, and the calcium hydroxide having an average particle size of about 0.25 μm to about 10 μm, but preferably about 0.5 μm to about 5 μm. It is contemplated that the relatively small particle size enables the compound to be more readily reactive with the environment. Once sourced, these components may then be mixed by any suitable means such as by hand mixing or through use of a tumbler. The resulting compound is then ready to be applied to soil, which may be performed using existing methods of additive distribution such as by hand spreading or by using a farm spreader. Once applied, the compound may begin to capture and store carbon dioxide from the environment year-round (unlike natural soil carbon sequestration). The combination of calcium hydroxide and basalt produces a balanced soil environment, the effects of which are diminished when either component is applied alone

Optionally, in or more embodiments the compound may also contain a quantity of fertilizer to further facilitate plant growth. For example, conventional nitrogen/phosphorous/potassium (NPK) fertilizers may be mixed with the basalt and calcium hydroxide and applied to soil. This fertilizer may be provided in any suitable form, including liquid, dry particulate, and/or controlled-release form. It is generally contemplated that the combined effect of improving soil quality (e.g., by applying the compound) and providing plant nutrients (e.g., by applying the fertilizer) may culminate into an optimum growing environment for plants and crops.

Additionally, in some cases, the compound may further be suitable for application to bodies of water (e.g., lakes and ponds). As those skilled in the art will appreciate, bodies of water may also depend on a delicate pH balance and certainly also contains carbonic acid. For these reasons, it is contemplated that the pH buffering ability and carbon mineralization aspect of the compound may find utility in bodies of water.

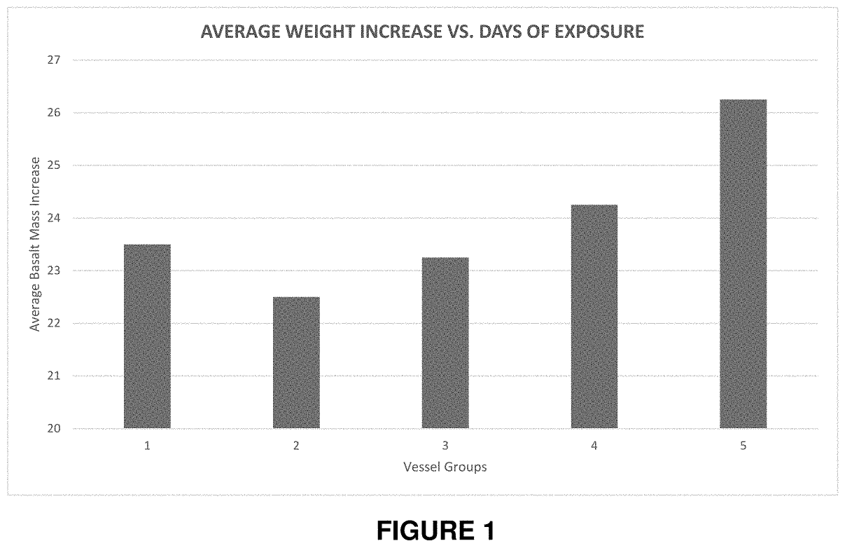

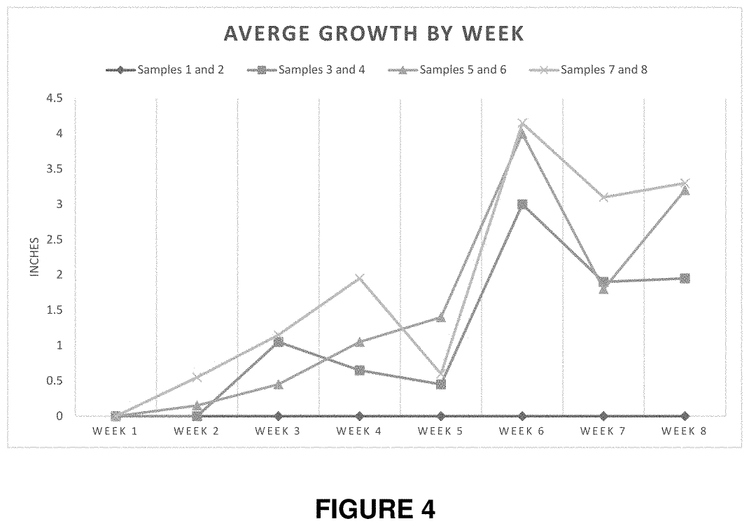

Referring to FIG. 1, in a first experiment (herein “Experiment 1”) it is demonstrated that basalt is capable of capturing carbon over a five-day period. This experiment was performed by preparing 20 vessels and organizing them into groups 1-5 with each group consisting of 4 vessels. Approximately 220 grams of basalt was added to each vessel. The basalt was sourced from BuildASoil, LLC of Montrose, Colorado. Approximately 3.5 milliliters of carbonated water was then added to each vessel and, immediately upon doing so, each vessel was sealed to maintain an airtight environment. Each vessel was also agitated (e.g., shaken) to ensure proper mixing. After one day, the vessels of group 1 were opened and allowed to dry completely. The resulting mass of the basalt in these vessels were then weighed and recorded, with any difference in weight being attributable to the carbon dioxide that was sequestered. This process of opening, drying, weighing and recording was then repeated for the vessels of the remaining groups on each successive day (i.e., group 2 was opened, dried, weighed, and recorded on day 2; group 3 was opened, dried, weighed, and recorded on day 3, and so forth). FIG. 4 shows the average weight increase for each group. Group 1 saw an average weight increase of 23.5 grams, group 2 saw an average weight increase of 22.5 grams, group 3 saw an average weight increase of 23.25 grams, group 4 saw an average weight increase of 24.25 grams, and group 5 saw an average weight increase of 26.25 grams. From these results it is demonstrated that basalt is able to sequester carbon dioxide relatively quickly upon exposure to carbonated water (e.g., with the greatest increase in weight being shown over the course of the first day) and will continue to do so over the course of at least five days.

In a second experiment (herein “Experiment 2”), it is demonstrated that the addition of calcium hydroxide to basalt drastically improves the rate at which carbon dioxide is sequestered. Experiment 2 was an indoor experiment that entailed preparing two vessels (Vessels 1 and 2) by placing approximately 207.4 grams of the compound in each vessel. Both vessels were generally cylindrical, approximately 4.25 inches in height, and approximately 3.25 inches in diameter. The compound used for Experiment 2 consisted of 50% by weight calcium hydroxide (sourced from Asian Dragon Group, Inc. of Spokane, Wash.) and 50% by weight basalt (sourced from BuildASoil, LLC of Montrose, Co.). 23.3 grams of carbonated water was then permitted to sit and dissipate gaseous carbon dioxide, leaving 7.7 grams of remaining carbonated water. This carbonated water was then added to Vessel 1 while an equal amount of regular water (devoid of added carbon dioxide) was added to Vessel 2. The vessels were then permitted to dry over a 5-day period and the resulting mass of the compound in each vessel was recorded. The mass of Vessel 1 weighed 272.3 grams and the mass of Vessel 2 weighed 264.6 grams, correlating to weight increases of 64.9 grams and 57.2 grams respectfully. The carbon dioxide sequestration rate of Vessel 1 was approximately 0.3129 grams of carbon dioxide per gram of compound. Notably, this increase in weight is twice the amount of weight increase shown in Experiment 1 (which only evaluated basalt) even though a smaller quantity of basalt was used. Further, it is calculated that if 7.7 grams of the increased weight of the compound in Vessel 1 is attributable to the carbonated water, then that would lead to an air-to-water carbon dioxide sequestration rate of 88.14% (air) and 11.86% (water) respectfully. Moreover, visual observation of the vessels revealed the presence of mineral formation along the top surface of the compound, which was verified to calcium carbonate (i.e., evidence of carbon capture) by a qualitive analysis conducted by reacting a small amount of this mineral formation with aqueous hydrochloric acid (evidenced by the production of CO₂ gas and water).

In a third experiment (herein “Experiment 3”), it is demonstrated that the compound is capable of sequestering environmental carbon dioxide (i.e., not in carbonated water). Experiment 3 was performed by filling a vessel with approximately 1,735 grams of the compound, placing the vessel outside, and permitting it to remain exposed. Here, the vessel had an open surface area of approximately 128.25 square inches. The compound consisted of 50% by weight basalt and 50% by weight calcium hydroxide. The weight of the compound was then measured and recorded after 18- and 22-day time periods. This revealed an increased weight of 92 grams and 188 grams, respectively, and correlates to a carbon dioxide sequestration rate of approximately 0.0530 grams and 0.1084 grams of carbon dioxide per gram of compound, respectively. Further, the presence of mineral formation was again observed along the top surface and verified to be calcium carbonate by reacting it with hydrochloric acid. By these results, it is demonstrated that the combination of calcium hydroxide and basalt is capable of sequestering carbon dioxide from the environment.

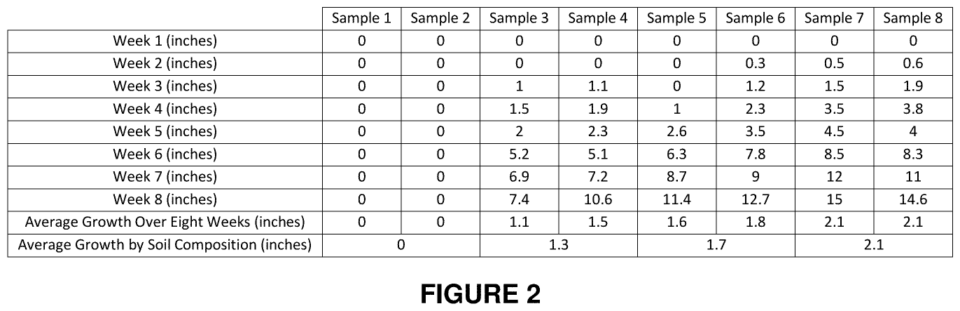

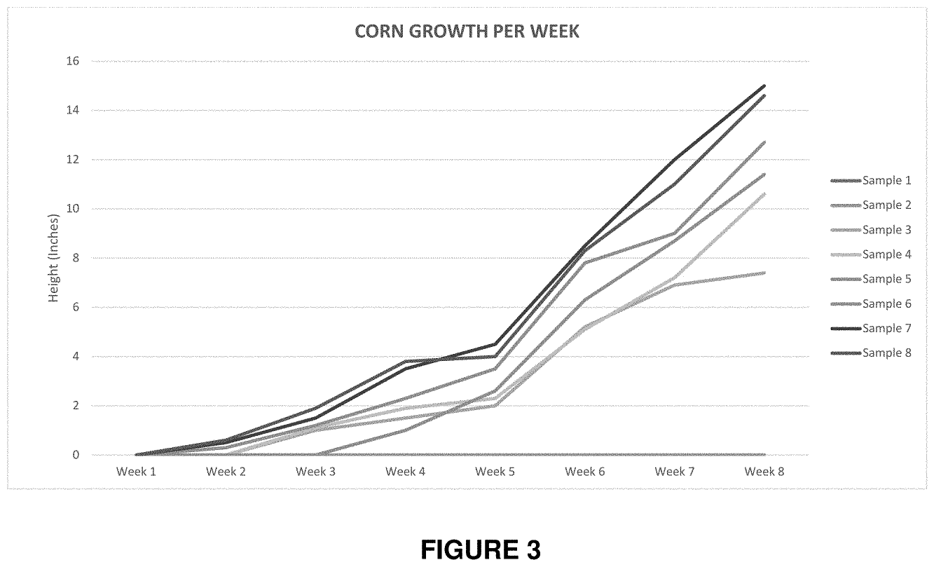

Referring to FIGS. 2-4, in a fourth experiment (herein “Experiment 4”) it is demonstrated that basalt is capable of improving plant growth over the course of eight weeks. In conducting Experiment 4, sweet corn was grown from corn seeds planted in four different soil compositions. The soil compositions were created by mixing the commercially available garden soil, sourced from Garden Safe, Ltd. of Wilington, Bedford, United Kingdom, with basalt sourced from BuildASoil, LLC of Montrose, Col. Samples 1 and 2 were controls and used a soil composition consisting only of soil, samples 3 and 4 used a soil composition consisting of soil and approximately 25% by weight basalt, samples 5 and 6 used a soil composition consisting of soil and approximately 33% by weight basalt, and samples 7 and 8 used a soil consisting of soil and approximately 50% by weight basalt. Each of these samples were watered in regular intervals once daily, maintained at a temperature of approximately 55° F. to approximately 75° F., and grown under grow lights running on a 24-hour cycle. As shown, the addition of basalt (samples 3-8) was able to facilitate plant growth in soil conditions that otherwise would not be suitable (samples 1 and 2). Moreover, increasing the basalt content in the soil compositions is directly correlated to an increase plant growth with a twofold gain in plant growth when comparing samples 7 and 8 to samples 3 and 4 (comparing week 8 results). Due to the efficacy of basalt demonstrated by this experiment, it is contemplated that other types crops that are similar to sweet corn may also benefit from the addition of basalt. These crops may include, but are not limited to, other members of the maize family (e.g., corn, wheat, rice, barley, etc.) as well as legumes (e.g., alfalfa, beans, peas, lentils, soybeans, peanuts, etc.).

Any embodiment of the present invention may include any of the features of the other embodiments of the present invention. The exemplary embodiments herein disclosed are not intended to be exhaustive or to unnecessarily limit the scope of the invention. The exemplary embodiments were chosen and described in order to explain the principles of the present invention so that others skilled in the art may practice the invention. Having shown and described exemplary embodiments of the present invention, those skilled in the art will realize that many variations and modifications may be made to the described invention. Many of those variations and modifications will provide the same result and fall within the spirit of the claimed invention. It is the intention, therefore, to limit the invention only as indicated by the scope of the claims.

What is claimed is:

1. A compound comprising:
a quantity of calcium hydroxide;
a quantity of basalt comprising a combined magnesium oxide and silicon oxide content of at least 20% by weight; and
wherein the quantity of calcium hydroxide is relative to the quantity of basalt at a ratio ranging from about 1:6 to about 6:1 by weight.

2. The compound of claim 1 wherein the quantity of basalt comprises a quantity of at least one olivine mineral.

3. The compound of claim 2 wherein the quantity of basalt comprises a quantity of forsterite.

4. The compound of claim 1 wherein the quantity of basalt comprises a quantity of at least one plagioclase feldspar mineral.

5. The compound of claim 4 wherein the quantity of basalt comprises a quantity of anorthite.

6. The compound of claim 1 wherein the quantity of calcium hydroxide is relative to the quantity of basalt at a ratio ranging from about 1:4 to about 4:1 by weight.

7. The compound of claim 1 wherein the quantity of calcium hydroxide is relative to the quantity of basalt at a ratio ranging from about 3:2 to about 7:13 by weight.

8. The compound of claim 1 wherein the quantity of basalt comprises a magnesium content of about 20% to about 50% by weight.

9. The compound of claim 1 wherein the quantity of basalt comprises a magnesium content of about 30% to about 40% by weight.

10. The compound of claim 1 wherein the quantity of basalt comprises quantities of at least one of iron, potassium, potassium oxide, phosphate, aluminum oxide, and sodium oxide.

11. The compound of claim 1 wherein at least one of the quantities of basalt and the quantity of calcium hydroxide is in a dry particulate form.

12. The compound of claim 1 wherein the quantity of basalt has an average particle size ranging from about 6 μm to about 300 μm.

13. The compound of claim 1 wherein the quantity of calcium hydroxide has an average particle size ranging from about 0.5 μm to about 5 μm.

14. The compound of claim 1 wherein the quantity of calcium hydroxide and the quantity of basalt is mixed in a substantially homogenous distribution.

15. The compound of claim 1 further comprising a quantity of plant fertilizer.

16. The compound of claim 15 wherein the quantity of plant fertilizer comprises at least one of nitrogen, phosphorous, and potassium.

17. A compound comprising:
a quantity of calcium hydroxide;
a quantity of basalt;
wherein at least one of the quantities of basalt and the quantity of calcium hydroxide is in a dry particulate form; and
wherein the quantity of calcium hydroxide is relative to the quantity of basalt at a ratio ranging from about 3:2 to about 7:13 by weight.

18. The compound of claim 17 wherein the quantity of basalt has an average particle size of about 12 μm.

19. A compound comprising:
a quantity of calcium hydroxide;
a quantity of basalt comprising forsterite and anorthite;
wherein the quantity basalt further comprises quantities of at least one of iron, potassium, potassium oxide, phosphate, aluminum oxide, and sodium oxide.
